(19) United States
(12) Patent Application Publication
(10) Pub. No.: US 2008/0167410 A1
(43) Pub. Date: Jul. 10, 2008

(54) Polyester Resin Composition and Plastic Article

(76) Inventors: In Sik SHIM, Uiwang-si (KR); Jong Cheol Lim, Anyang-si (KR)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/965,962

(22) Filed: Dec. 28, 2007

(30) Foreign Application Priority Data
Dec. 29, 2006 (KR) 2006-0138268

(51) Int. Cl. C08K 5/521; C08K 3/32

(52) U.S. Cl. 524/147; 524/539; 524/417; 524/153

(57) ABSTRACT

Disclosed herein are a polyester resin composition and a plastic article produced from the resin composition. The polyester resin composition comprises about 100 parts by weight of a polybutylene terephthalate base resin, about 10 to about 50 parts by weight of a polyethylene terephthalate glycol resin, about 0.1 to about 10 parts by weight of an inorganic filler, and about 0.01 to about 5 parts by weight of a resin stabilizer.

### CROSS-REFERENCE TO RELATED APPLICATIONS

This non-provisional application claims priority under 35 USC Section 119 from Korean Patent Application No. 2006-0138268, filed on Dec. 29, 2006, which is hereby incorporated by reference in its entirety.

### FIELD OF THE INVENTION

The present invention relates to a polyester resin composition and a plastic article.

### BACKGROUND OF THE INVENTION

In a conventional method for producing a metal-deposited reflector, e.g., a head lamp bezel for automobiles, a reflector or an illuminator, primer-application is performed prior to metal-deposition, to improve the surface smoothness of the metal-deposited reflector. However, since the primer contains an organic solvent, the method can have a negative environmental impact. In addition, it can take a long time to form a coating film, which in turn can result in higher production costs and lower productivity.

For this reason, recently, metal has been directly applied to the surface of a light-reflective side, without applying any primer thereto.

In order to employ such a direct deposition, the metal-deposited reflector must exhibit not only superior surface smoothness, but also excellent heat resistance so that it does not undergo deformation when being applied to a head lamp bezel for automobiles, an illuminator, and the like.

Accordingly, a variety of efforts have been made to develop a material that satisfies the requirements of surface smoothness and heat resistance and is thus suitable for use as a metal-deposited reflector.

However, conventionally known or researched materials still have unsolved problems such as insufficient heat resistance and poor surface smoothness and do not satisfactorily exhibit physical properties which are required for metal-deposited reflector materials to which direct deposition is applied.

### SUMMARY OF THE INVENTION

The present invention has been made to solve the foregoing problems of the prior art and it is one aspect of the present invention to provide a polyester resin composition capable of improving physical properties, e.g., heat resistance and surface smoothness, of a thermoplastic polyester resin.

It is another aspect of the present invention to provide a plastic article produced from the polyester resin composition.

In accordance with one aspect of the present invention, there is provided a polyester resin composition comprising: about 100 parts by weight of a polybutylene terephthalate base resin; about 10 to about 50 parts by weight of a polyethylene terephthalate glycol resin; about 0.1 to about 10 parts by weight of an inorganic filler; and about 0.01 to about 5 parts by weight of a resin stabilizer.

In accordance with another aspect of the present invention, there is provided a plastic article produced from the polyester resin composition.

Details of other aspects and exemplary embodiments of the present invention are encompassed in the following detailed description.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

In one aspect, the present invention is directed to a polyester resin composition comprising about 100 parts by weight of a polybutylene terephthalate base resin, about 10 to about 50 parts by weight of a polyethylene terephthalate glycol resin, about 0.1 to about 10 parts by weight of an inorganic filler, and about 0.01 to about 5 parts by weight of a resin stabilizer.

Since the polyester resin composition comprises, in addition to a polybutylene terephthalate base resin as an essential ingredient, a polyethylene terephthalate glycol resin, an inorganic filler and a resin stabilizer, in a desirable content range, it is capable of imparting improved physical properties such as heat resistance and surface smoothness to a thermoplastic polyester resin.

Accordingly, the polyester resin composition is suitable as a material for a metal-deposited reflector, e.g., a head lamp bezel for automobiles, a reflector or an illuminator.

A more detailed explanation of respective ingredients constituting the polyester resin composition will be given below.

The polyester resin composition comprises a polybutylene terephthalate base resin.

As the polybutylene terephthalate base resin, for example, a polybutylene terephthalate polymer may be used which is polycondensed by direct-esterification or transesterification between 1,4-butanediol and terephthalic acid or dimethyl terephthalate.

Alternatively, as the polybutylene terephthalate base resin, there may be used a copolymer or mixture of polybutylene terephthalate and an impact strength-reinforcing ingredient selected from polytetramethylene glycol (PTMG), polyethylene glycol (PEG), polypropylene glycol (PPG), low-molecular-weight aliphatic polyester (Mw about 400 to about 6,000 g/mol), aliphatic polyamide, and the like, and combinations thereof. The impact strength-reinforcing ingredient is copolymerized or mixed with the polybutylene terephthalate base resin so as to impart more improved impact strength to the polybutylene terephthalate base resin.

In addition, the polybutylene terephthalate base resin has an intrinsic viscosity η (measured in an o-chlorophenol solvent at 25° C.) of about 0.36 to about 1.60, for example about 0.52 to about 1.25. When the intrinsic viscosity is less than about 0.36, the mechanical properties of the thermoplastic polyester resin may be undesired. Meanwhile, when the intrinsic viscosity exceeds about 1.60, the moldability of the thermoplastic polyester resin may be deteriorated.

The polyester resin composition further comprises a polyethylene terephthalate glycol resin. The polyethylene terephthalate glycol resin is an amorphous polyethylene terephthalate copolymer containing 1,4-cyclohexanedimethanol (CHDM) as a copolymer ingredient and is a copolyester resin in which ethylene glycol constituting a polyethylene terephthalate resin is partially substituted by 1,4-cyclohexanedimethanol.

As the polyethylene terephthalate glycol resin, for example, there may be used a polyethylene terephthalate resin in which about 3 to about 48 mol %, for example about 5 to about 20 mol %, of ethylene glycol of a polyethylene terephthalate resin is substituted by 1,4-cyclohexanedimethanol. When the amount of 1,4-cyclohexanedimethanol substituted is less than about 3 mol %, the surface smoothness of the thermoplastic polyester resin may be not improved to a desired level. Meanwhile, when the amount of 1,4-cyclohexanedimethanol substituted exceeds about 48 mol %, the heat resistance of the thermoplastic polyester resin may be deteriorated.

The polyethylene terephthalate glycol resin is present in the polyester resin composition of the invention in an amount of about 10 to about 50 parts by weight, based on about 100 parts by weight of the polybutylene terephthalate base resin. When the content of the polyethylene terephthalate glycol resin is less than about 10 parts by weight, the surface smoothness of the thermoplastic polyester resin may not be satisfactorily improved. Meanwhile, when the content of the polyethylene terephthalate glycol resin exceeds about 50 parts by weight, the heat resistance of the thermoplastic polyester resin may be deteriorated.

The polyester resin composition comprises further an inorganic filler. The inclusion of the inorganic filler in the polyester resin composition enables improvement in mechanical properties or heat resistance of the thermoplastic polyester resin.

Examples of suitable inorganic fillers include titanium whisker, talc, wollastonite, bentonite, montmorillonite, calcium carbonate, clay, kaolin, and the like. The inorganic filler may be used alone or in combination thereof. The inorganic filler that can be used for the polyester resin composition is not limited to these examples. Any inorganic filler may be used without particular limitation so long as it is conventionally used in the art.

The inorganic filler has an average diameter (d50 measured by laser diffraction particle size analyzer) of about 0.1 to about 2 μm, for example about 0.3 to about 1 μm. When the average diameter of the inorganic filler is less than about 0.1 μm, the dispersibility of the inorganic filler may be deteriorated and the heat resistance of the thermoplastic polyester resin is thus undesirable. Meanwhile, when the average diameter of the inorganic filler exceeds about 2 μm, the surface smoothness of the thermoplastic polyester resin may be deteriorated.

Use of an inorganic filler whose surface is coated with an organic compound can improve dispersibility with the polybutylene terephthalate base resin or the polyethylene terephthalate glycol resin.

The inorganic filler is present in the polyester resin composition of the invention in an amount of about 0.1 to about 10 parts by weight, based on about 100 parts by weight of the polybutylene terephthalate base resin. When the content of the inorganic filler is less than about 0.1 parts by weight, the heat resistance of the thermoplastic polyester resin may be deteriorated. Meanwhile, when the content of the inorganic filler exceeds about 10 parts by weight, the surface smoothness of the thermoplastic polyester resin may be deteriorated.

The polyester resin composition comprises a resin stabilizer, in addition to the respective ingredients.

For example, during the preparation of the thermoplastic polyester resin or the plastic article from the polyester resin composition through extrusion or injection, the resin stabilizer stabilizes the polybutylene terephthalate base resin or polyethylene terephthalate glycol resin contained in the polyester resin composition and prevents decomposition (e.g., thermal decomposition) of these resins.

The incorporation of the resin stabilizer into the polyester resin composition enables the polybutylene terephthalate base resin or the polyethylene terephthalate glycol resin contained therein to exhibit their inherent properties more favorably. Accordingly, physical properties, such as surface smoothness or heat resistance, of the polyester thermoplastic resin can be greatly improved.

Any resin stabilizer may be used without particular limitation so long as it is conventionally known in the art. Exemplary resin stabilizers suitable for use in the present invention include resin stabilizers selected from the group consisting of phosphoric acid, triphenyl phosphite, trimethyl phosphite, triisodecyl phosphate, tri-(2,4-di-t-butylphenyl)phosphate, 3,5-di-t-butyl-4-hydroxybenzyl phosphonic acid and, the like, and mixtures thereof.

The resin stabilizer is present in the polyester resin composition of the invention in an amount of about 0.01 to about 5 parts by weight, based on about 100 parts by weight of the polybutylene terephthalate base resin. When the content of the resin stabilizer exceeds about 5 parts by weight, the mechanical properties of the thermoplastic polyester resin may be deteriorated.

The polyester resin composition can be prepared by mixing the aforementioned ingredients with one another. The polyester thermoplastic resin can be prepared from the polyester resin composition by a conventional method such as melt-extrusion in an extruder. The plastic article can be produced from the polyester thermoplastic resin.

In another aspect, the present invention is directed to a plastic article produced from the polyester resin composition. The plastic article, for example, can include a resin matrix comprising a polybutylene terephthalate base resin and a polyethylene terephthalate glycol resin which are substantially homogeneously mixed with each other, and an inorganic filler and a resin stabilizer, each of which is dispersed in the resin matrix.

Because the plastic article comprises a resin matrix comprising a polybutylene terephthalate base resin and a polyethylene terephthalate glycol resin, the resins substantially homogeneously mixed with each other, and an inorganic filler and a resin stabilizer, each of which is also substantially homogeneously dispersed in the resin matrix, it can exhibit more improved physical properties, e.g., heat resistance or surface smoothness, through interactions between the respective ingredients thereof.

Accordingly, the plastic article is suitable for use in the production of a metal-deposited reflector, e.g., a head lamp bezel for automobiles, a reflector or an illuminator.

Hereinafter, the present invention will be better understood from the following examples. However, these examples are given for illustrative purposes and are not to be construed as limiting the scope of the invention.

The following is a more detailed description of ingredients, i.e., (A) polybutylene terephthalate base resin B) polyethylene terephthalate glycol resin, (C) inorganic filler, (D) resin stabilizer, (E) polyethylene terephthalate resin (Comparative Example) and (F) polycarbonate resin (Comparative Example), used in the following Examples and Comparative Examples.

### (A) Polybutylene Terephthalate Base Resin

The polybutylene terephthalate base resin used herein is a polybutylene terephthalate polymer having an intrinsic viscosity η of 1.0 (measured in an o-chlorophenol solvent at 25° C.)

### (B) Polyethylene Terephthalate Glycol Resin

The polyethylene terephthalate glycol resin used herein is an amorphous polyethylene terephthalate copolymer which contains 3 to 48 mol % of 1,4-cyclohexanedimethanol as a copolymer ingredient and has an intrinsic viscosity η of 0.8 (measured in an o-chlorophenol solvent at 25° C.).

### (C) Inorganic Filler

The inorganic filler used herein is talc with an average diameter 0.5 μm.

### (D) Resin Stabilizer

The resin stabilizer used herein is a mixture (1:2) of IRGANOX B 215 (IRGANOX 1010, hindered phenolic antioxidant) and IRGAFOS 168 (organophosphite), both of which are available from Ciba Geigy Corp.

### (E) Polyethylene Terephthalate Resin (Comparative Example)

The polyethylene terephthalate resin used herein is a polyethylene terephthalate resin having an intrinsic viscosity η of 0.8 (measured in an o-chlorophenol solvent at 25° C.).

### (F) Polycarbonate Resin (Comparative Example)

The polycarbonate resin used herein is a bisphenol-A polycarbonate resin having a weight average molecular weight (Mw) of 25,000 g/mol.

### EXAMPLES 1 & 3 AND COMPARATIVE EXAMPLES 1 TO 6

The respective ingredients mentioned above are mixed in accordance with the composition as set forth in Table 1 to prepare a polyester resin composition, and the composition is then melted and mixed in a melt twin-screw extruder (Φ=45 mm) at 240 to 280° C. to prepare a polyester resin in the form of a chip. The chip thus obtained is dried at 130° C. for 5 hours or more and introduced into a screw-injection machine at 240 to 280° C. to prepare a flat sample (width 10 cm×length 10 cm×thickness 0.3 cm) for measurement of physical properties.

TABLE 1

| | Examples No. | | | Comparative Examples No. | | | | | |
|---|---|---|---|---|---|---|---|---|---|
| | 1 | 2 | 3 | 1 | 2 | 3 | 4 | 5 | 6 |
| (A) Polybutylene terephthalate | 100 | 100 | 100 | 100 | 100 | 100 | 100 | 100 | 100 |
| resin | | | | | | | | | |
| (B) Polyethylene terephthalate | 20 | 40 | 40 | — | 40 | 80 | 40 | — | — |
| glycol resin | | | | | | | | | |
| (C) Inorganic filler | 3 | 3 | 1 | 3 | — | 3 | 15 | 3 | 3 |
| (D) Resin stabilizer | 0.5 | 0.5 | 0.5 | 0.5 | 0.5 | 0.5 | 0.5 | 0.5 | 0.5 |
| (E) Polyethylene terephthalate | — | — | — | — | — | — | — | 40 | — |
| resin | | | | | | | | | |
| (F) Polycarbonate resin | — | — | — | — | — | — | — | — | 40 |

The physical properties of the sample are measured in accordance with the following methods.

First, the heat resistance of the sample is measured in accordance with ASTM (American Standard Test Method) D648 used to measure heat resistance of plastics (Heat resistance evaluation).

The gloss of the sample is measured using a gloss meter (Gloss evaluation).

Aluminum is directly vacuum-deposited on the sample using an aluminum deposition system, without a coating of primer on the sample. A square plate of 10×10 mm is partitioned into 100 cells having a size of 1 mm×1 mm, and the level of the aluminum stripped from the plate is measured with a scratch test using a tape (evaluation of aluminum deposition efficiency).

A surface roughness R_{z} is measured in accordance with the following method (surface smoothness evaluation).

A 10-point average surface roughness Rz is determined as a distance between an average height of the first to the fifth highest peaks and an average height of the first to the fifth lowest valleys, in accordance with an ISO-roughness method, as depicted in Reference fig. I below:

L is an arbitrary length measured (usually 3 mm).

R1,R3, . . . R9 are the first to the fifth highest peaks and R2,R4, . . . R10 are the first to the fifth lowest peaks.

The average surface roughness Rz is obtained from Equation I below:

$${R}_{z} = \frac{( {R}_{1} + {R}_{3} + … + {R}_{9} ) - ( {R}_{2} + {R}_{4} + … + {R}_{10} )}{5} \qquad Equation I$$

The physical property values thus measured are shown in Table 2 below.

TABLE 2

| | | Heat | | | |
|---|---|---|---|---|---|
| | | resistance | | Aluminum deposition | |
| | | (° C.) | Gloss | efficiency (%) | R_{z} (μm) |
| Example | 1 | 175 | 93 | 3 | 0.10 |
| No. | 2 | 168 | 95 | 2 | 0.10 |
| | 3 | 160 | 96 | 2 | 0.09 |
| Comparative | 1 | 182 | 83 | 6 | 0.18 |
| No. | 2 | 145 | 96 | 2 | 0.08 |
| | 3 | 142 | 95 | 5 | 0.09 |
| | 4 | 181 | 85 | 10 | 0.16 |
| | 5 | 178 | 81 | 5 | 0.20 |
| | 6 | 140 | 93 | 2 | 0.14 |

The data of Table 2 demonstrates that the samples of Examples 1 to 3, which comprise a polybutylene terephthalate base resin, a polyethylene terephthalate glycol resin, an inorganic filler and a resin stabilizer, exhibit more improved properties such as gloss, aluminum deposition efficiency and surface smoothness, while maintaining heat resistance, when compared to the sample of Comparative Example 1, which comprises no polyethylene terephthalate glycol resin.

In addition, the data of Table 2 demonstrates that the samples of Examples 1 to 3 exhibit not only more improved surface smoothness, but also superior heat resistance or gloss, as compared to the samples of Comparative Examples 5 and 6, which comprise a polycarbonate resin and a polyethylene terephthalate resin, respectively, instead of the polyethylene terephthalate glycol resin.

Further, it can be seen that the samples of Example 1 to 3 exhibit more improved heat resistance, while exhibiting equivalent gloss, aluminum deposition efficiency and surface smoothness, as compared to the sample of Comparative Example 2, which comprises no inorganic filler.

Further, it can be seen that the samples of Example 1 to 3, which comprise respective ingredients within a desirable content range, exhibit superior heat resistance (as compared to Comparative Example 3), and high gloss, excellent surface smoothness and good aluminum deposition efficiency (as compared to Comparative Example 4), as compared to the samples of Comparative Examples 3 and 4 which comprise respective ingredients outside of the content range.

In conclusion, these results demonstrate that the samples of Examples 1 to 3 according to the present invention are superior in terms of overall physical properties such as gloss, heat resistance, surface smoothness and aluminum deposition efficiency.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polyester resin composition comprising:
about 100 parts by weight of a polybutylene terephthalate base resin;
about 10 to about 50 parts by weight of a polyethylene terephthalate glycol resin;
about 0.1 to about 10 parts by weight of an inorganic filler; and
about 0.01 to about 5 parts by weight of a resin stabilizer.

2. The polyester resin composition according to claim 1, wherein the polybutylene terephthalate base resin includes a polybutylene terephthalate polymer polycondensed by direct esterification or transesterification between 1,4-butanediol and terephthalic acid or dimethyl terephthalate.

3. The polyester resin composition according to claim 1, wherein the polybutylene terephthalate base resin includes a polybutylene terephthalate copolymer or mixture of polybutylene terephthalate and a compound selected from polytetramethylene glycol (PTMG), polyethylene glycol (PEG), polypropylene glycol (PPG), low-molecular-weight aliphatic polyester or aliphatic polyamide.

4. The polyester resin composition according to claim 1, wherein the polybutylene terephthalate base resin has an intrinsic viscosity η (measured in an o-chlorophenol solvent at 25° C.) of about 0.36 to about 1.60.

5. The polyester resin composition according to claim 1, wherein the polyethylene terephthalate glycol resin includes a resin in which about 3 to about 48 mol % of ethylene glycol of a polyethylene terephthalate resin is substituted by 1,4-cyclohexanedimethanol.

6. The polyester resin composition according to claim 1, wherein the inorganic filler includes titanium whisker, talc, wollastonite, bentonite, montmorillonite, calcium carbonate, clay, kaolin or a mixture thereof.

7. The polyester resin composition according to claim 1, wherein the inorganic filler has an average diameter of about 0.1 to about 2 μm.

8. The polyester resin composition according to claim 1, wherein the resin stabilizer is selected from the group consisting of phosphoric acid, triphenyl phosphite, trimethyl phosphite, triisodecyl phosphate, tri-(2,4-di-t-butylphenyl)phosphate, 3,5-di-t-butyl-4-hydroxybenzyl phosphonic acid and mixtures thereof.

9. A plastic article produced from the polyester resin composition according to claim 1.

10. A plastic article comprising:
a resin matrix comprising about 100 parts by weight of a polybutylene terephthalate base resin and about 10 to about 50 parts by weight of a polyethylene terephthalate glycol resin, the resins being substantially homogeneously mixed with each other; and
about 0.1 to about 10 parts by weight of an inorganic filler and about 0.01 to about 5 parts by weight of a resin stabilizer, each being dispersed in the resin matrix.
